(19) United States
(12) Patent Application Publication
(10) Pub. No.: US 2026/0284806 A1
(43) Pub. Date: Sep. 24, 2026

(54) WELDING SYSTEM FOR A HEAVY CONSTRUCTION EQUIPMENT CABIN

(71) Applicant: BRILS Co., Ltd., Incheon (KR)

(72) Inventors: Won Jai CHOI, Incheon (KR); Se Chun KI, Cheongju-si Chungcheongbuk-do (KR); Jin JEON, Incheon (KR)

(73) Assignee: BRILS Co., Ltd., Incheon (KR)

(21) Appl. No.: 19/561,875

(22) Filed: Mar. 10, 2026

(30) Foreign Application Priority Data
Mar. 21, 2025 (KR) 10-2025-0036669

(51) Int. Cl. B23K 37/04; B23K 31/12; B23K 101/00

(52) U.S. Cl. CPC B23K 37/0452; B23K 31/125; B23K 37/0435; B23K 2101/006

(57) ABSTRACT

A welding system for a heavy construction equipment cabin capable of producing a cabin of heavy construction equipment by automated multi-axis welding is provided. The welding system includes a welding positioner apparatus on which a workpiece is seated, and configured to perform multi-axis motion control of at least two axes with respect to the seated workpiece; a welding apparatus disposed at one side of the welding positioner apparatus to face the workpiece seated on the welding positioner apparatus, and configured to weld the workpiece seated on the welding positioner apparatus by a welder mounted on an articulated robot; a seam tracking apparatus disposed at the other side of the welding positioner apparatus, and configured to track a welding seam of a welding portion of the workpiece seated on the welding positioner apparatus by a seam tracking sensor mounted on an articulated robot; and a controller.

### CROSS-REFERENCE TO RELATED PATENT APPLICATION

This application claims the benefit under 35 U.S.C. § 119 of Korean Patent Application No. 10-2025-0036669, filed on Mar. 21, 2025, the disclosure of which is hereby incorporated by reference in its entirety.

### BACKGROUND OF THE INVENTION

### 1. Field of the Invention

The present disclosure relates to a welding system for a heavy construction equipment cabin, and more particularly, to a welding system for a heavy construction equipment cabin capable of manufacturing a cabin of heavy construction equipment by automated multi-axis welding.

### 2. Description of Related Art

Heavy construction equipment used in civil and architectural engineering is an essential element for construction work such as civil and architectural engineering for human habitation. In accordance with trends of large-scale, high-rise, deep-depth, and automated construction work, the proportion of heavy construction equipment will increase in the future. That is, heavy construction equipment is a major factor for successful construction work, and its importance will be further highlighted to perform efficient work with a small number of personnel at present, where it is difficult to secure a workforce.

Representative heavy construction equipment currently includes excavators, dump trucks, concrete mixer trucks, concrete pump cars, cranes, forklifts, and the like, and there are working vehicles for construction machinery specially designed to perform various purpose operations (aerial ladder, crane, forklift work, harvesting of rice/field crops, excavation work) based on a traveling unit.

Here, attachments (working devices) required for various construction works may be mounted on the heavy construction equipment as described above. For example, refer to various modules such as a bucket, a breaker, a drill, and a grab attached thereto including device (equipment, working part) such as a boom or an arm of an excavator.

In addition, a cabin (driver's seat) for a driver provided with a controller (manipulator) required for the above-described attachment operation is installed in the heavy construction equipment, and various construction works such as extraction of sand and gravel, crushing, and demolition work as well as excavation work for tunnel and underground space construction can be performed by the operation of the attachment according to the controller manipulation.

Such a cabin of the heavy construction equipment may be manufactured by forming a thin plate into an inner plate and an outer plate of a required shape by press forming and joining the formed inner plate and the outer plate by welding, thereby implementing an outer appearance including a front surface and an upper surface of the cabin in various curved shapes.

However, such a conventional cabin of the heavy construction equipment is manufactured by a worker manually performing a welding operation, which takes too much time in a manufacturing process. In a process of manually welding while moving a position of the cabin which is a heavy structure for changing a welding posture, there is a high possibility of worker injury. Also, due to manual work, the quality of welding is not constant, so efficiency of the entire cabin manufacturing process is lowered, and there are problems with a high possibility of defects.

### SUMMARY OF THE INVENTION

The present disclosure is intended to solve various problems including the problems as described above, and an object of the present disclosure is to provide a welding system for a heavy construction equipment cabin capable of producing a cabin of heavy construction equipment by automated multi-axis welding by performing multi-axis motion control of at least two axes with respect to a seated workpiece. However, these objects are illustrative, and the scope of the present disclosure is not limited thereby.

According to an embodiment of the present disclosure, a welding system for a heavy construction equipment cabin is provided. The welding system for a heavy construction equipment cabin may include: a welding positioner apparatus on which a workpiece is seated, and configured to perform multi-axis motion control of at least two axes with respect to the seated workpiece; a welding apparatus disposed at one side of the welding positioner apparatus to face the workpiece seated on the welding positioner apparatus, and configured to weld the workpiece seated on the welding positioner apparatus by a welder mounted on an articulated robot; a seam tracking apparatus disposed at the other side of the welding positioner apparatus to face the workpiece seated on the welding positioner apparatus from a position different from the welding apparatus, and configured to track a welding seam of a welding portion of the workpiece seated on the welding positioner apparatus by a seam tracking sensor mounted on an articulated robot; and a controller configured to control multi-axis motion of the welding positioner apparatus such that the welding portion of the workpiece is positioned within an operation range of the welder of the welding apparatus and an operation range of the seam tracking sensor of the seam tracking apparatus.

According to an embodiment of the present disclosure, the welding positioner apparatus may include: a support stage on which the workpiece is seated; a multi-axis motion unit configured to support the support stage to be rotatable based on at least a first rotational axis and a second rotational axis perpendicular to the first rotational axis so as to enable multi-axis motion control of at least two axes with respect to the support stage; and a clamp module rotatably installed at both ends of a seating portion of the support stage on which the workpiece is seated so as to clamp the workpiece seated on the support stage, and configured to selectively press at least a portion of a lower frame of the workpiece. The controller may be configured to control multi-axis motion of the multi-axis motion unit such that the welding portion of the workpiece is positioned within the operation range of the welder and the operation range of the seam tracking sensor during welding of the workpiece.

According to an embodiment of the present disclosure, the multi-axis motion unit may include: a body frame; a first motion module installed at one end of the body frame to support the support stage, and configured to rotate the support stage based on the first rotational axis; and a second motion module installed at the other end of the body frame to support the body frame, and configured to rotate the body frame based on the second rotational axis.

According to an embodiment of the present disclosure, the first motion module may include: a first motion body installed to contact both inner walls of the body frame so as to be positioned inside the body frame at one end of the body frame formed in an "H" shape as a whole; a rotation plate installed on an upper side of the first motion body to be rotatable based on the first rotational axis, and configured to support the support stage; and a first motion motor installed on a lower side of the first motion body, and configured to rotationally drive the rotation plate.

According to an embodiment of the present disclosure, the first motion body may be rotatably installed based on a third rotational axis parallel to the second rotational axis at the one end of the body frame.

According to an embodiment of the present disclosure, the multi-axis motion unit may further include a third motion module configured to rotationally drive the first motion body by a third motion motor installed at the one end of the body frame to contact an outer wall of the body frame.

According to an embodiment of the present disclosure, the second motion module may include: a second motion body installed at the other end of the body frame formed in an "H" shape as a whole to contact both outer walls of the body frame, and configured to support the body frame in a cantilever configuration as a hinge part while supporting the body frame to be rotatable based on the second rotational axis; and a second motion motor installed at one side of the second motion body, and configured to rotationally drive the body frame.

According to an embodiment of the present disclosure, the second motion module may further include a support cylinder formed to have a variable length so as to support the one end of the body frame supported in the cantilever configuration by the second motion body or to assist rotational driving of the body frame by the second motion motor, and connecting a lower end of the second motion body and the one end of the body frame.

According to an embodiment of the present disclosure, the multi-axis motion unit may further include a fourth motion module configured to slide and move the second motion module in a linear axis perpendicular to the second rotational axis.

According to an embodiment of the present disclosure, the fourth motion module may include: a fourth motion body formed to extend in a rectangular parallelepiped shape along the linear axis; a plurality of guide rails formed to extend in a rail configuration along the linear axis, and installed on an upper side of the fourth motion body; a sliding stage installed on the upper side of the fourth motion body to be slidably movable along the plurality of guide rails, and configured to support the second motion body; and a sliding drive unit installed at the fourth motion body, and configured to slide and drive the sliding stage.

According to an embodiment of the present disclosure, the sliding drive unit may include: a ball screw formed to extend in a rod shape along the linear axis, and rotatably installed on the upper side of the fourth motion body; a movable nut coupled to a lower side of the sliding stage and screw-coupled to the ball screw, and installed to be slidably movable together with the sliding stage in an extension direction of the ball screw according to rotational driving of the ball screw; and a fourth motion motor installed at one side of the fourth motion body, and configured to rotationally drive the ball screw.

According to an embodiment of the present disclosure, the controller may be configured to control the welding apparatus such that the welder is operated along the welding seam tracked by the seam tracking sensor, and control multi-axis motion of the multi-axis motion unit such that the welding seam tracked by the seam tracking sensor is positioned within an operation range of the welder by the articulated robot.

According to an embodiment of the present disclosure, the seam tracking sensor may include at least one vision sensor so as to track the welding seam of the welding portion by vision inspection.

According to an embodiment of the present disclosure composed as described above, the welding positioner apparatus on which the workpiece is seated is supported by the multi-axis motion unit to be capable of automatic rotation and sliding movement in multi-axes of at least two axes, thereby facilitating a change in a welding posture of the workpiece such that, even when the welding portion is changed during welding of the workpiece, the changed welding portion is positioned within an operation range of a multi-axis automatic welding apparatus for welding the workpiece and an operation range of a multi-axis seam tracking apparatus for tracking a welding seam of the welding portion, and inducing a welding operation to be performed uniformly.

In addition, by controlling the welder of the multi-axis welding apparatus to be operated along the welding seam tracked by the seam tracking sensor of the multi-axis seam tracking apparatus during welding of the workpiece, the welding operation can be induced to be precisely performed at an accurate position.

As such, by automating the welding operation of the workpiece having a heavy weight such as the cabin of the heavy construction equipment by the automated multi-axis welding system, it is possible to reduce a possibility of worker injury that may occur during the change of the welding posture of the cabin which is a heavy structure, and to implement the welding system for a heavy construction equipment cabin capable of increasing efficiency of a cabin manufacturing process of the heavy construction equipment by improving quality of welding by welding in a constant welding posture. Of course, the scope of the present disclosure is not limited by these effects.

### BRIEF DESCRIPTION OF THE DRAWINGS

FIG. 1 is a perspective view schematically illustrating a welding system for a heavy construction equipment cabin according to an embodiment of the present disclosure.

FIGS. 2 and 3 are cross-sectional views schematically illustrating the welding system for a heavy construction equipment cabin of FIG. 1.

FIG. 4 is a partial perspective view schematically illustrating a state in which a seam tracking apparatus tracks a welding seam of a welding portion of a workpiece seated on a welding positioner apparatus in the welding system for a heavy construction equipment cabin of FIG. 1.

FIG. 5 is a partial perspective view schematically illustrating a state in which a welding apparatus welds a welding portion of a workpiece seated on a welding positioner apparatus in the welding system for a heavy construction equipment cabin of FIG. 1.

FIG. 6 is a perspective view schematically illustrating the welding positioner apparatus of the welding system for a heavy construction equipment cabin of FIG. 1.

FIG. 7 is a cross-sectional view schematically illustrating the welding positioner apparatus of FIG. 6.

FIG. 8 is an enlarged view illustrating portion "A" of FIG. 6.

FIG. 9 is an enlarged view illustrating portion "B" of FIG. 7.

FIGS. 10 and 11 are perspective views schematically illustrating a multi-axis motion unit of the welding positioner apparatus of FIG. 6.

### DETAILED DESCRIPTION OF THE INVENTION

Hereinafter, various preferred embodiments of the present disclosure will be described in detail with reference to the accompanying drawings.

Embodiments of the present disclosure are provided to more completely explain the present disclosure to those skilled in the art, and the following embodiments may be modified in various other forms, and the scope of the present disclosure is not limited to the following embodiments. Rather, these embodiments are provided so that this disclosure will be thorough and complete, and will fully convey the spirit of the present disclosure to those skilled in the art. In addition, the thickness or size of each layer in the drawings is exaggerated for convenience and clarity of description.

Hereinafter, embodiments of the present disclosure will be described with reference to the drawings schematically illustrating ideal embodiments of the present disclosure. In the drawings, for example, variations of the illustrated shape may be expected depending on manufacturing technology and/or tolerance. Therefore, embodiments of the technical spirit of the present disclosure should not be construed as being limited to the specific shape of the region illustrated herein, but should include, for example, a change in shape resulting from manufacturing.

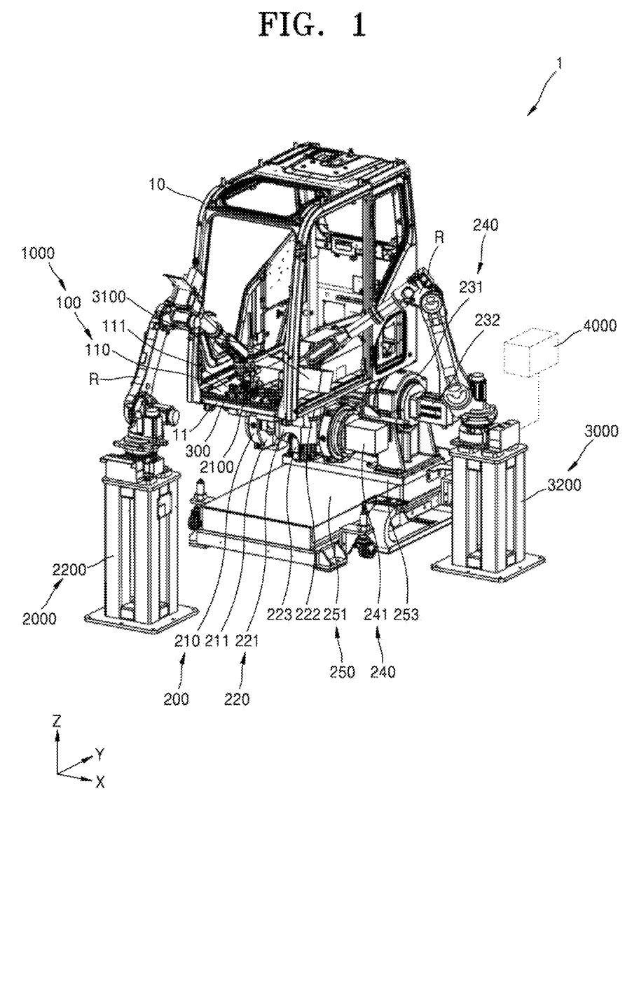

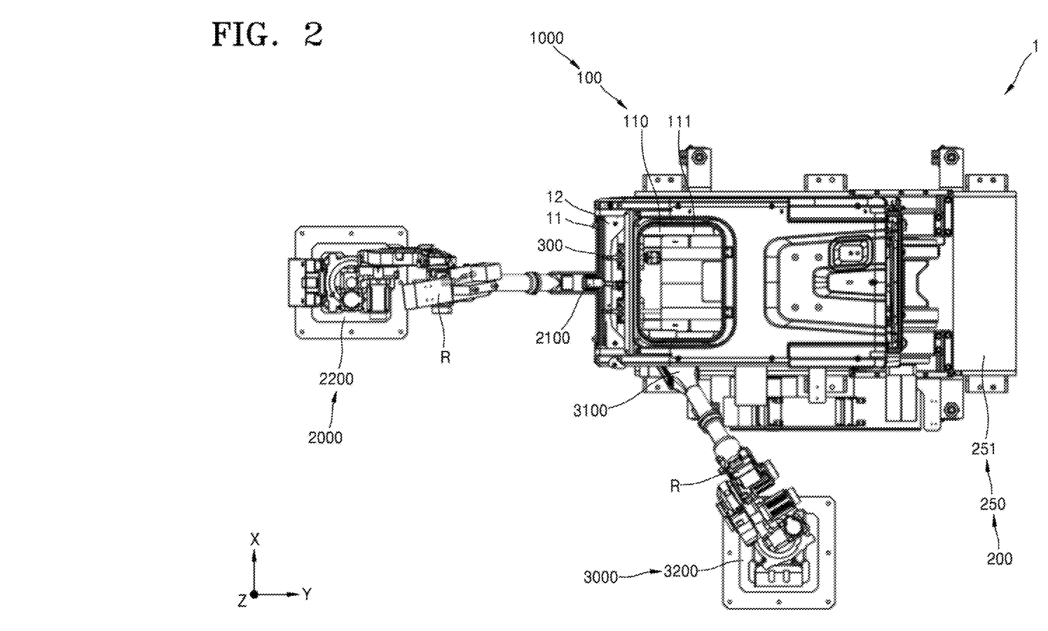

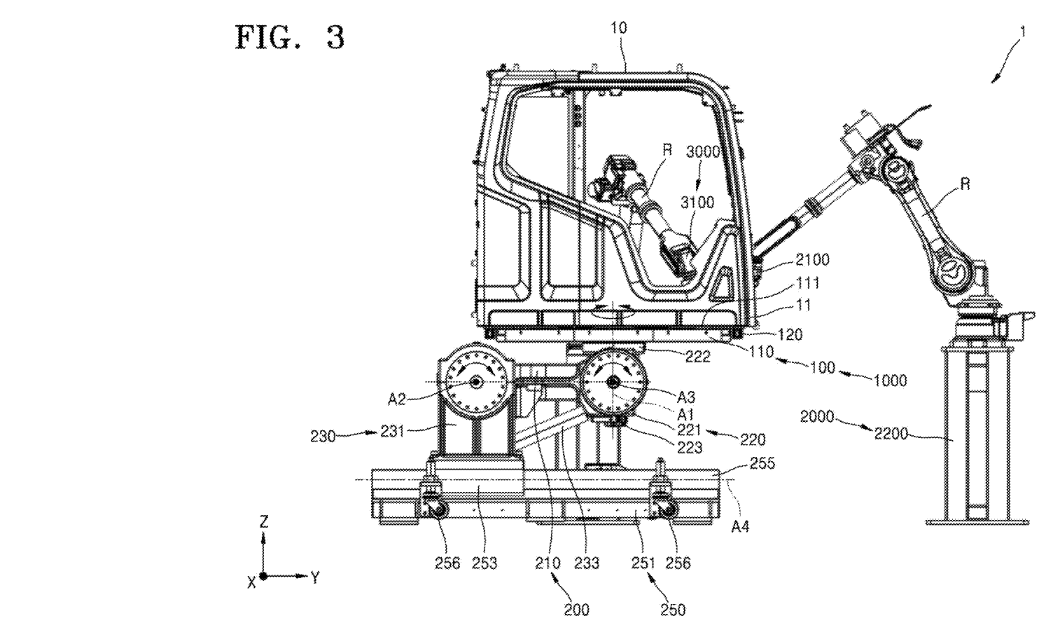

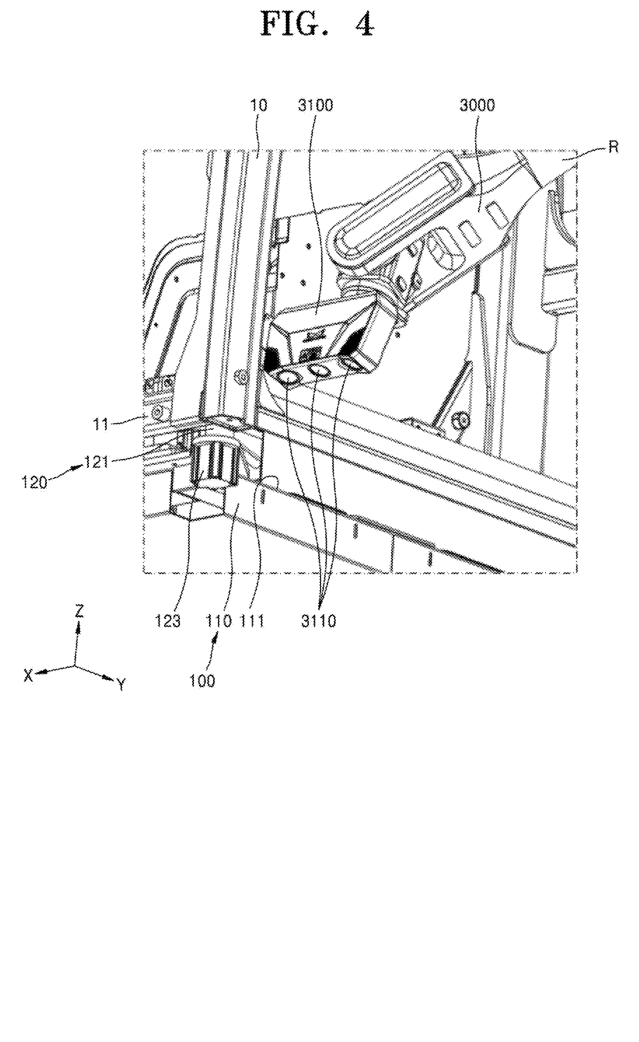

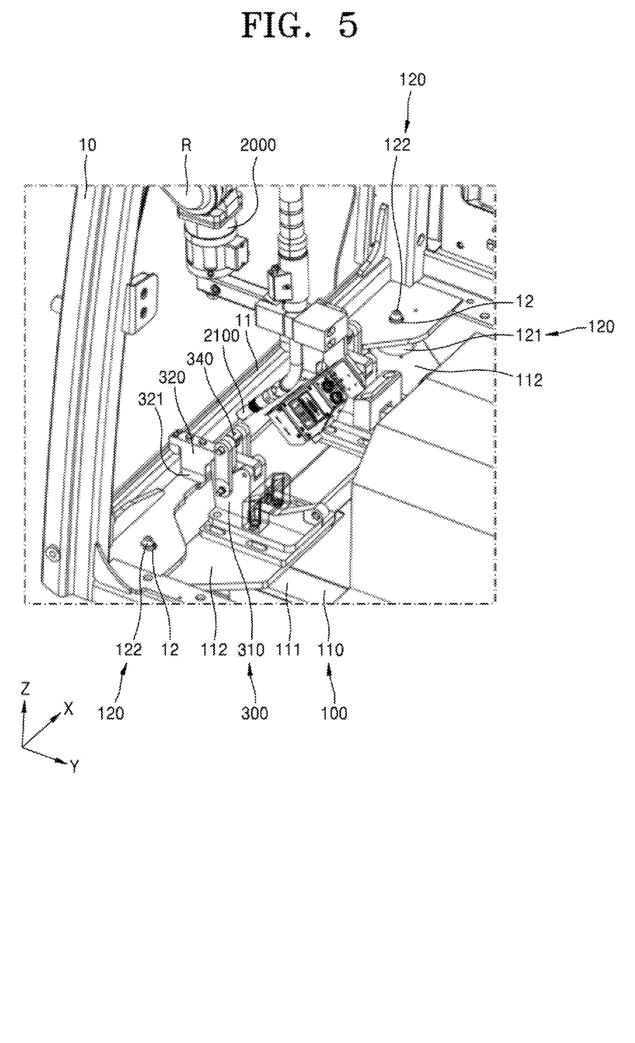

FIG. 1 is a perspective view schematically illustrating a welding system 1 for a heavy construction equipment cabin according to an embodiment of the present disclosure, and FIGS. 2 and 3 are cross-sectional views schematically illustrating the welding system 1 for a heavy construction equipment cabin of FIG. 1. In addition, FIG. 4 is a partial perspective view schematically illustrating a state in which a seam tracking apparatus 3000 tracks a welding seam of a welding portion of a workpiece 10 seated on a welding positioner apparatus 1000 in the welding system 1 for a heavy construction equipment cabin of FIG. 1, and FIG. 5 is a partial perspective view schematically illustrating a state in which a welding apparatus 2000 welds a welding portion of a workpiece 10 seated on a welding positioner apparatus 1000 in the welding system 1 for a heavy construction equipment cabin of FIG. 1.

First, as shown in FIGS. 1 to 3, the welding system 1 for a heavy construction equipment cabin according to an embodiment of the present disclosure may largely include a welding positioner apparatus 1000, a welding apparatus 2000, a seam tracking apparatus 3000, and a controller 4000.

As shown in FIGS. 1 to 3, the seam tracking apparatus 3000 is disposed at the other side of the welding positioner apparatus 1000 so as to face the workpiece 10 seated on the welding positioner apparatus 1000 from a position different from the welding apparatus 2000, and may track a welding seam of a welding portion of the workpiece 10 seated on the welding positioner apparatus 1000 by a seam tracking sensor 3100 mounted on an articulated robot R.

For example, the seam tracking apparatus 3000 may include a seam tracking base 3200 installed at the other side in an X-axis direction with respect to the welding positioner apparatus 1000 configured to perform multi-axis motion control of the workpiece 10, an articulated robot R configured as a multi-joint structure and installed on the seam tracking base 3200, and configured to perform multi-axis motion control of the seam tracking sensor 3100, and a seam tracking sensor 3100 installed at an end of the articulated robot R, and configured to track the welding seam of the welding portion of the workpiece 10.

As shown in FIG. 4, the seam tracking sensor 3100 may include at least one vision sensor 3110 so as to track the welding seam of the welding portion by vision inspection.

More specifically, the seam tracking sensor 3100 may be installed such that a plurality of vision sensors 3110 face the welding portion at different angles so as to track the welding seam of the welding portion in three dimensions by vision inspection and transmit three-dimensional welding coordinates to the welding apparatus 2000 through the controller 4000.

As such, the seam tracking sensor 3100 is a vision inspection device capable of tracking the welding seam of the welding portion by three-dimensional vision inspection using the plurality of vision sensors 3110, and may also perform a role of inspecting a welding result of the welding portion by vision inspection when the welding apparatus 2000 welds the welding portion based on the three-dimensional coordinates of the welding seam tracked by the seam tracking sensor 3100.

Accordingly, the controller 4000 electrically connected to the seam tracking apparatus 3000 may receive a welding image of the welding portion from the plurality of vision sensors 3110 after welding of the workpiece 10, determine whether the welding portion is defective based on the welding image, and apply a re-welding control signal to the welding apparatus 2000 so as to re-weld the corresponding welding portion when it is determined that the corresponding welding portion is defective.

To this end, the controller 4000 may store a normal image of a normal welding state of the welding portion of the workpiece 10 in advance and compare the welding image of the welding portion received from the plurality of vision sensors 3110 after welding of the workpiece 10 with the normal image, thereby determining whether the welding portion corresponding to the welding image is defective.

As shown in FIGS. 1 to 3 and 5, the welding apparatus 2000 is disposed at one side of the welding positioner apparatus 1000 so as to face the workpiece 10 seated on the welding positioner apparatus 1000 from a position different from the seam tracking apparatus 3000, and may weld the welding portion of the workpiece 10 seated on the welding positioner apparatus 1000 by a welder 2100 mounted on an articulated robot R.

For example, the welding apparatus 2000 may include a welding base 2200 installed at one side in a Y-axis direction with respect to the welding positioner apparatus 1000 configured to perform multi-axis motion control of the workpiece 10, an articulated robot R configured as a multi-joint structure and installed on the welding base 2200, and configured to perform multi-axis motion control of the welder 2100, and a welder 2100 installed at an end of the articulated robot R, and configured to weld the welding portion of the workpiece 10.

The welding apparatus 2000 may perform multi-axis motion control of the welder 2100 based on the three-dimensional welding coordinates tracked by the seam tracking apparatus 3000 and transmitted through the electrically connected controller 4000.

In the above-described embodiment, it is exemplified that, based on the welding positioner apparatus 1000, the welding apparatus 2000 is installed at one side in the Y-axis direction and the seam tracking apparatus 3000 is installed at the other side in the X-axis direction so as to face the workpiece 10 seated on the welding positioner apparatus 1000 in directions perpendicular to each other, but the present disclosure is not limited thereto, and they may be disposed in very various directions with respect to the welding positioner apparatus 1000 according to a structure of the workpiece 10.

As shown in FIG. 1, the controller 4000 is installed to be electrically connected to the welding positioner apparatus 1000, the welding apparatus 2000, and the seam tracking apparatus 3000, and may control multi-axis motion of the welding positioner apparatus 1000 such that the welding portion of the workpiece 10 is positioned within an operation range of the welder 2100 of the welding apparatus 2000 and an operation range of the seam tracking sensor 3100 of the seam tracking apparatus 3000.

More specifically, the controller 4000 may control the welding apparatus 2000 such that the welder 2100 of the welding apparatus 2000 is operated along the welding seam tracked by the seam tracking sensor 3100 of the seam tracking apparatus 3000, and control multi-axis motion of a multi-axis motion unit 200 of the welding positioner apparatus 1000 such that the welding seam tracked by the seam tracking sensor 3100 is positioned within an operation range of the welder 2100 by the articulated robot R.

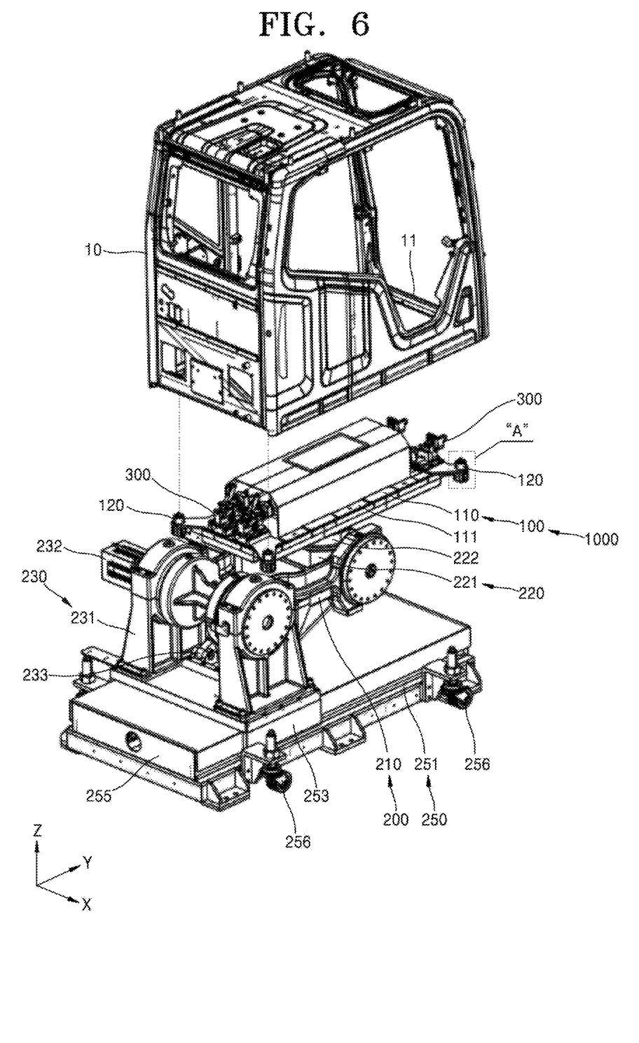

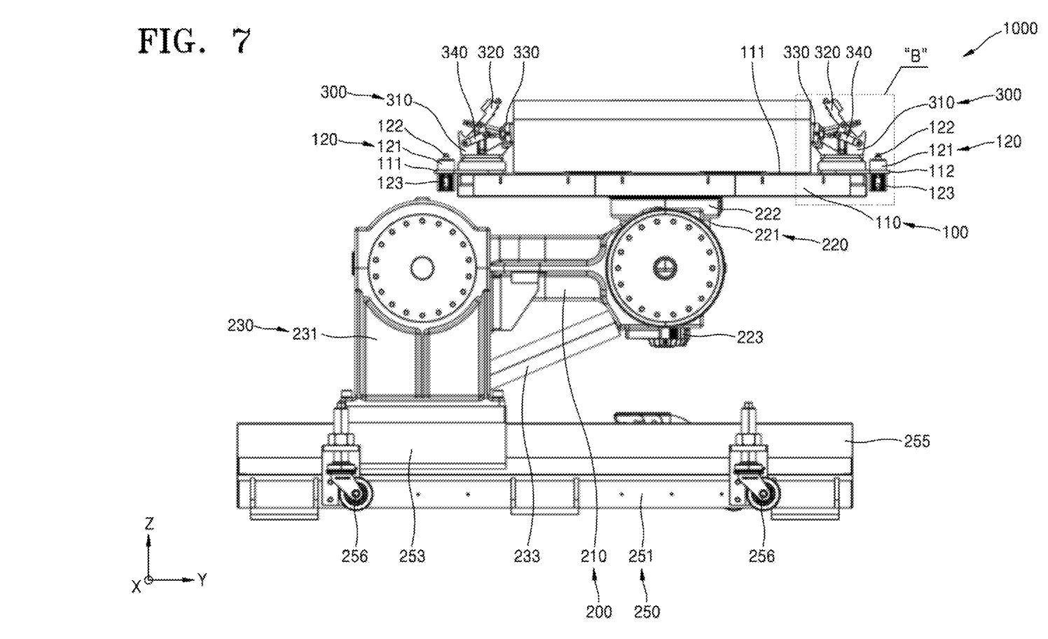

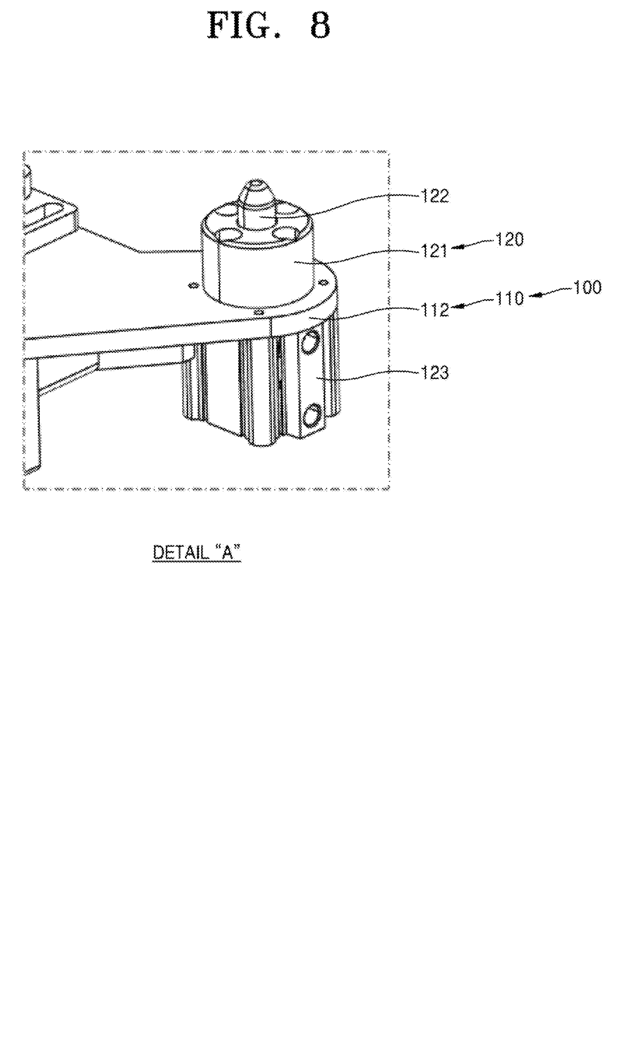

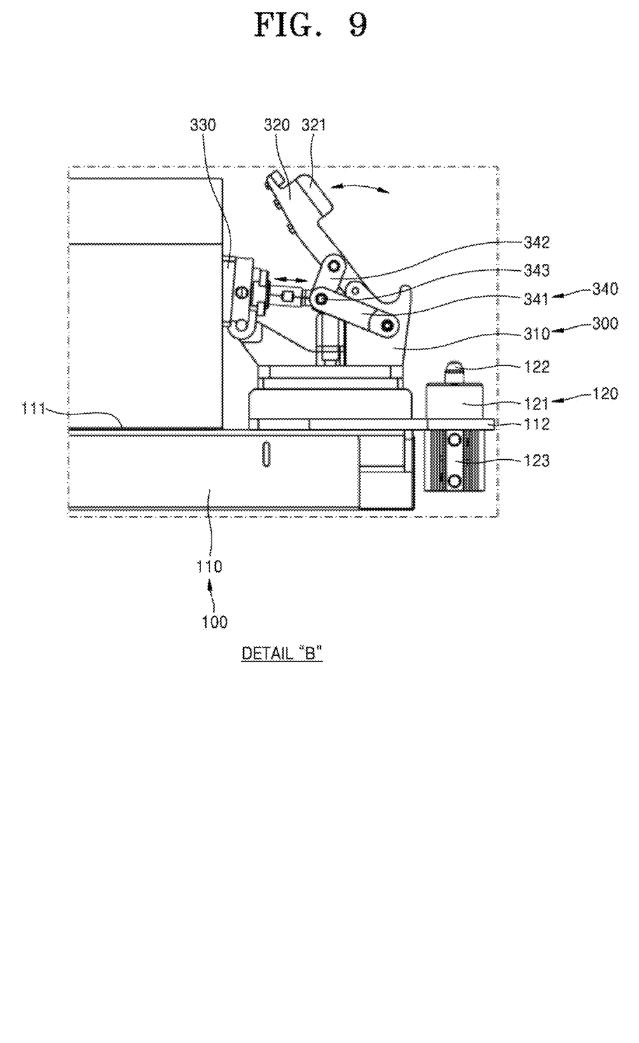

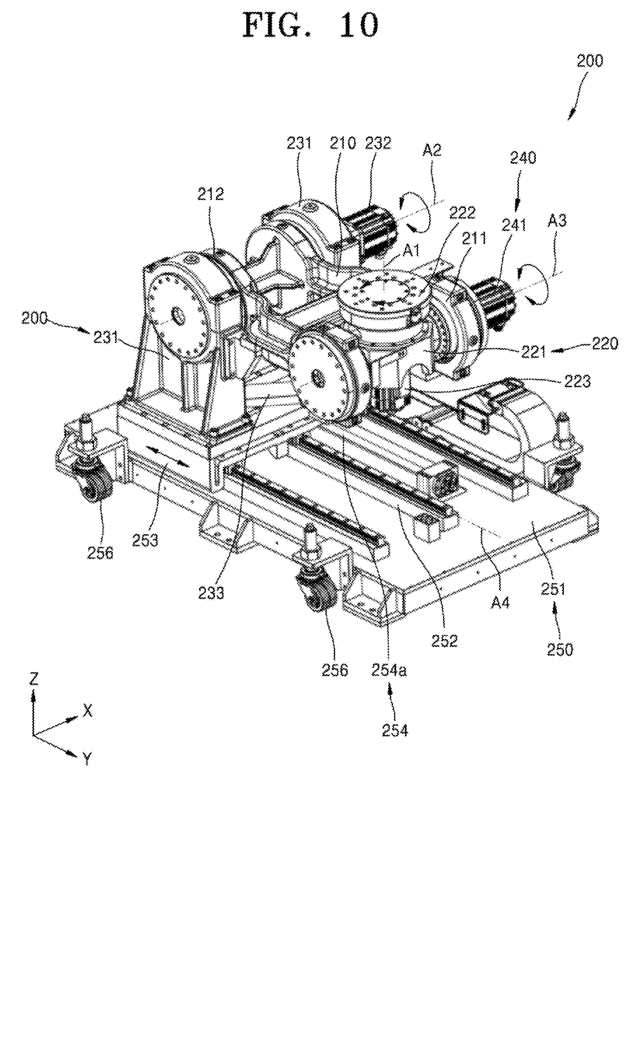

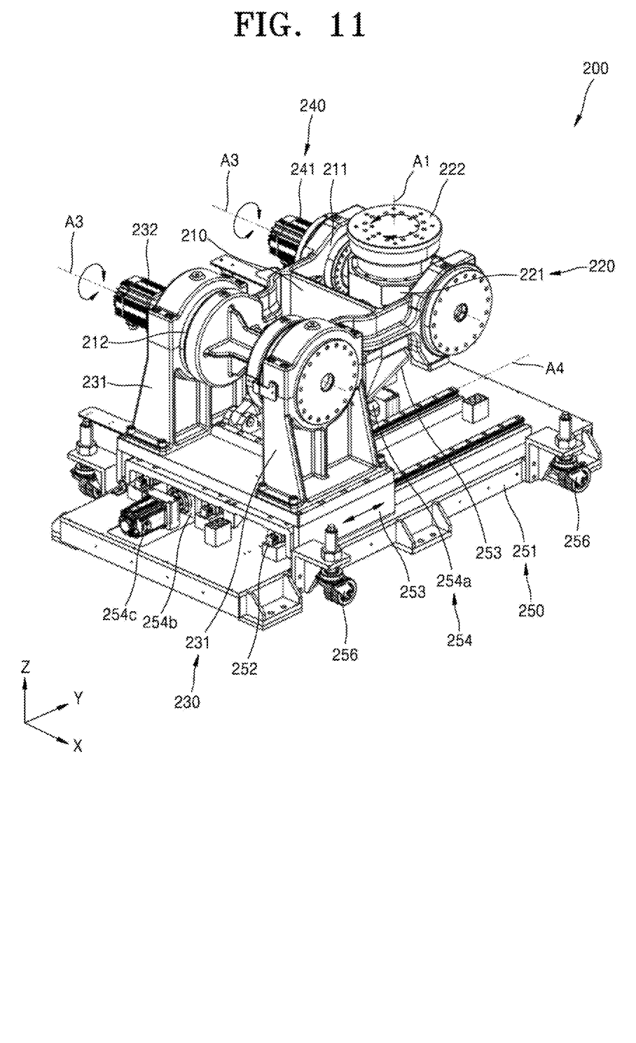

FIG. 6 is a perspective view schematically illustrating the welding positioner apparatus 1000 of the welding system 1 for a heavy construction equipment cabin of FIG. 1, and FIG. 7 is a cross-sectional view schematically illustrating the welding positioner apparatus 1000 of FIG. 6. In addition, FIG. 8 is an enlarged view illustrating portion "A" of FIG. 6, FIG. 9 is an enlarged view illustrating portion "B" of FIG. 7, and FIGS. 10 and 11 are perspective views schematically illustrating the multi-axis motion unit 200 of the welding positioner apparatus 1000 of FIG. 6.

First, as shown in FIGS. 6 and 7, the welding positioner apparatus 1000 may largely include a support stage 100, a multi-axis motion unit 200, and a clamp module 300.

As shown in FIGS. 6 and 7, the workpiece 10 may be seated on the support stage 100.

For example, the support stage 100 may include a stage body 110 formed in a shape of a rectangular plate as a whole so that a seating portion 111 on which the workpiece 10 is seated is formed, and a seating guide 120 installed at four corner portions of the stage body 110 formed in the shape of a rectangular plate, and configured to guide and support a seating position of the workpiece 10 seated on the stage body 110.

More specifically, as shown in FIGS. 6 to 9, the stage body 110 formed in the shape of a rectangular plate may be provided with support brackets 112 formed to protrude in a diagonal direction (a direction from a center of the stage body toward the corner portion) from the corner portions at the four corner portions.

In addition, the seating guide 120 may include a support bushing 121 formed in a shape of a cylinder as a whole and formed to protrude to an upper side of the support bracket 112, and a support pin 122 formed to protrude to an upper side of the support bushing 121.

The support bushing 121 is a structure for supporting a lower frame 11 of the workpiece 10 and is illustrated as being formed in a shape of a cylinder as a whole, but is not necessarily limited thereto, and may be formed in any pillar shape capable of supporting the lower frame 11 of the workpiece 10, such as a rectangular pillar shape or a polygonal pillar shape.

The support pin 122 is a structure inserted into a through-hole 12 formed in the lower frame 11 of the workpiece 10 so as to guide a seating fixed position of the workpiece 10 (see FIGS. 4 and 5), and is formed in a shape of a cylinder as a whole, but it may be preferable that at least a portion of an upper end is formed in a shape of a cone so as to facilitate insertion into the through-hole 12 and guide the seating fixed position.

In addition, the support pin 122 may be installed such that a protrusion height from the support bushing 121 can be adjusted by a driving motor 123 installed at a lower side of the support bracket 112. Accordingly, the support pin 122 may be formed to protrude to the upper side of the support bushing 121 only when the workpiece 10 is seated and may be selectively inserted into the support bushing 121 by being driven to descend when the workpiece 10 is detached.

As shown in FIGS. 6 and 7, the clamp module 300 may be rotatably installed at both ends of the seating portion 111 of the support stage 100 on which the workpiece 10 is seated so as to clamp the workpiece 10 seated on the support stage 100, thereby selectively pressing at least a portion of the lower frame 11 of the workpiece 10.

For example, a pair of clamp modules 300 may be installed to face away from each other at both ends in a longitudinal direction (Y-axis direction) of the support stage 100, and may be installed to be rotatable in directions opposite to each other. In addition, although it is exemplified that two clamp modules 300 are disposed along a width direction (X-axis direction) of the support stage 100, the present disclosure is not limited thereto, and it may be possible to dispose a very various number of clamp modules according to a length in the width direction (X-axis direction) of the support stage 100 or a weight and structure of the workpiece 10.

As shown in FIG. 9, the clamp module 300 may include a clamp hinge 310 installed at one end of the seating portion 111 of the support stage 100, a clamp body 320 rotatably installed at the clamp hinge 310, and configured to selectively press at least a portion of the lower frame 11 of the workpiece 10 during downward rotation (see FIG. 5), a rotation cylinder 330 installed on the seating portion 111 of the support stage 100 and formed to have a variable length so as to rotate the clamp body 320, and a two-bar linkage 340 connecting the rotation cylinder 330 and the clamp body 320 so as to convert linear motion of the rotation cylinder 330 into rotational motion of the clamp body 320.

More specifically, the clamp body 320 may be formed with an elastic member 321 at a contact portion with the lower frame 11 so that damage due to pressing does not occur to the lower frame 11 when pressing the lower frame 11.

In addition, the two-bar linkage 340 may include a first link 341 having one end rotatably connected to the clamp hinge 310 by a hinged joint, and a second link 342 having one end rotatably connected to the clamp body 320 by a hinged joint and the other end rotatably connected to the other end of the first link 341 by a hinged joint.

In this case, the rotation cylinder 330 may be connected to a rotation joint 343 where the other end of the first link 341 and the other end of the second link 342 of the two-bar linkage 340 are rotatably connected to each other so that the linear motion thereof can be converted into rotational motion of the clamp body 320.

Therefore, the workpiece 10 can be firmly seated and supported at a fixed position on the seating portion 111 of the support stage 100 by an cooperative operation of the structure of the seating guide 120 and the structure of the clamp module 300 of the support stage 100 described above.

As shown in FIGS. 6 and 7, the multi-axis motion unit 200 may support the support stage 100 so as to enable multi-axis motion control of at least two axes with respect to the support stage 100.

In this case, the controller (4000 in FIG. 1) is installed inside or outside the welding positioner apparatus 1000 so as to be electrically connected to the multi-axis motion unit 200, and may control multi-axis motion of the multi-axis motion unit 200 such that the welding portion of the workpiece 10 is positioned within an operation range of the multi-axis welding apparatus 2000 for welding the workpiece 10 during welding of the workpiece 10.

For example, as shown in FIGS. 10 and 11, the multi-axis motion unit 200 may support the support stage 100 to be rotatable and slidably movable based on a first rotational axis A1, a second rotational axis A2, a third rotational axis A3, and a linear axis A4 so as to enable multi-axis motion control of four axes with respect to the support stage 100.

The multi-axis motion unit 200 may largely include a body frame 210, a first motion module 220, a second motion module 230, a third motion module 240, and a fourth motion module 250.

The body frame 210 may be formed as a kind of frame structure formed in an "H" shape as a whole.

The first motion module 220 is installed at one end of the body frame 210 to support the support stage 100 and may rotate the support stage 100 based on the first rotational axis A1.

For example, the first motion module 220 may include a first motion body 221 installed to be in contact with both inner walls 211 of the body frame 210 so as to be positioned inside the body frame 210 at one end of the body frame 210 formed in the "H" shape as a whole, a rotating plate 222 rotatably installed based on the first rotational axis A1 on an upper side of the first motion body 221, and configured to support the support stage 100, and a first motion motor 223 installed at a lower side of the first motion body 221, and configured to rotationally drive the rotating plate 222.

In this case, the first motion body 221 may be installed to be in contact with both inner walls 211 of the body frame 210 by a rotational joint at one end of the body frame 210 so as to be rotatable based on the third rotational axis A3 parallel to the second rotational axis A2.

Accordingly, the third motion module 240 may rotationally drive the first motion body 221 by a third motion motor 241 installed to be in contact with an outer wall 212 of the body frame 210 at one end of the body frame 210.

The second motion module 230 is installed at the other end of the body frame 210 to support the body frame 210 and may rotate the body frame 210 based on the second rotational axis A2.

For example, the second motion module 230 may include a second motion body 231 installed to be in contact with both outer walls 212 of the body frame 210 at the other end of the body frame 210 formed in the "H" shape as a whole so as to support the body frame 210 as a hinge part in a cantilever configuration while rotatably supporting the body frame 210 based on the second rotational axis A2, and a second motion motor 232 installed at one side of the second motion body 231, and configured to rotationally drive the body frame 210.

A pair of second motion bodies 231 may be installed to be in contact with both outer walls 212 of the body frame 210 by a rotational joint at the other end of the body frame 210 so as to rotatably support the body frame 210 in a cantilever configuration based on the second rotational axis A2.

In addition, the second motion module 230 may further include a support cylinder 233 formed to have a variable length so as to support one end of the body frame 210 whose other end is supported in a cantilever configuration by the second motion body 231 or assist a rotational driving force of the body frame 210 by the second motion motor 232, and connecting a lower end of the second motion body 231 and one end of the body frame 210.

For example, the support cylinder 233 serves as a strut beam supporting one end of the body frame 210, whose other end is supported in a cantilever configuration by the second motion body 231, so that deflection does not occur due to self-weight of the first motion module 220 and the support stage 100 supported on an upper side thereof, and may serve as an auxiliary driving unit capable of reducing a torque load generated in the second motion motor 232 by distributing and supporting a weight of one end of the body frame 210 so as to prevent an excessive load from being applied to the second motion motor 232 rotationally driving the body frame 210 in a cantilever configuration at the other end of the body frame 210.

To this end, a hydraulic cylinder or a pneumatic cylinder performing only a role of load support by hydraulic pressure or pneumatic pressure formed therein without a separate power source may be applied as the support cylinder 233, but explicitly, an electric cylinder, a hydraulic cylinder, or a pneumatic cylinder capable of performing roles of load support and power assistance by performing linear motion by itself by a separate power source may also be applied.

The fourth motion module 250 may support the second motion module 230 and slidably move the second motion module 230 along the linear axis A4 perpendicular to the second rotational axis A2.

For example, the fourth motion module 250 may include a fourth motion body 251 formed to extend in a rectangular parallelepiped shape along the linear axis A4, a plurality of rail units 252 formed to extend in a rail shape along the linear axis A4 and installed on an upper side of the fourth motion body 251, a sliding stage 253 installed to be slidably movable along the plurality of rail units 252 on an upper side of the fourth motion body 251 and supporting the second motion body 231, and a sliding drive unit 254 installed on the fourth motion body 251 and configured to slidably drive the sliding stage 253.

The fourth motion body 251 is formed to extend in a rectangular parallelepiped shape along the linear axis A4 and may be installed on a floor surface of a manufacturing factory site, and a plurality of wheel members 256 may be installed along a side surface on a width direction (X-axis direction) side so as to facilitate movement in the manufacturing factory site.

The plurality of wheel members 256 may be installed to be movable upward or downward in a vertical direction (Z-axis direction) by screw coupling rotation such that a threaded rod installed on an upper side is screw-coupled to a nut part installed on a bracket installed on a side surface of the fourth motion body 251 so as to make rolling contact with the floor surface of the manufacturing factory site only when moving the welding positioner apparatus 1000.

In addition, the fourth motion body 251 may be formed with a cover member (see 255 in FIGS. 6 and 7) on an upper side such that the plurality of rail units 252 and the sliding drive unit 254 installed on the upper side are not exposed to the outside.

The sliding drive unit 254 may include a ball screw 254a formed to extend in a rod shape along the linear axis A4 and rotatably installed based on a center axis parallel to the linear axis A4 on the upper side of the fourth motion body 251, a movable nut 254b coupled to a lower side of the sliding stage 253, screw-coupled to the ball screw 254a, and installed to be slidably movable together with the sliding stage 253 in an extension direction (Y-axis direction) of the ball screw 254a according to rotational driving of the ball screw 254a, and a fourth motion motor 254c installed at one side of the fourth motion body 251 and configured to rotationally drive the ball screw 254a.

Here, linear driving by a combination of a ball screw and the movable nut 254b is exemplified as the sliding drive unit 254, but the present disclosure is not necessarily limited thereto, and linear driving by various combinations such as a combination of a worm gear and a rack gear capable of converting rotational motion of a motor into linear motion, a combination of a chain and a sprocket, or a combination of a belt and a pulley may be possible, and it may also be possible to apply a driving unit itself as a linear driving unit, such as an electric cylinder, a hydraulic cylinder, or a pneumatic cylinder.

Therefore, according to the welding system 1 for a heavy construction equipment cabin according to various embodiments of the present disclosure, the welding positioner apparatus 1000 on which the workpiece 10 is seated is supported to be automatically rotatable and slidably movable in multiple axes of at least two axes or more by the multi-axis motion unit 200, thereby facilitating a change in a welding posture of the workpiece 10 and inducing a welding operation to be performed uniformly such that, even when a welding portion is changed during welding of the workpiece 10, the changed welding portion is positioned within an operation range of the multi-axis automatic welding apparatus 2000 for welding the workpiece 10 and an operation range of the multi-axis seam tracking apparatus 3000 tracking a welding seam of the welding portion.

In addition, during welding of the workpiece 10, by controlling the welder 2100 of the multi-axis welding apparatus 2000 to be operated along the welding seam tracked by the seam tracking sensor 3100 of the multi-axis seam tracking apparatus 3000, it is possible to induce the welding operation to be performed precisely at an accurate position.

Therefore, by automating the welding operation of the workpiece 10 having a heavy weight, such as a cabin of heavy construction equipment, by the automated multi-axis welding system, it is possible to implement the welding system 1 for a heavy construction equipment cabin capable of reducing a possibility of injury to a worker that may occur during a change in a welding posture of the cabin, which is a heavy structure, improving welding quality by welding in a constant welding posture, and increasing efficiency of a cabin manufacturing process of heavy construction equipment.

Although the present disclosure has been described with reference to the embodiments illustrated in the drawings, this is merely exemplary, and those skilled in the art will understand that various modifications and other equivalent embodiments are possible therefrom. Therefore, the true technical protection scope of the present disclosure should be determined by the technical spirit of the appended claims.

What is claimed is:

1. A welding system for a heavy construction equipment cabin, comprising:
a welding positioner apparatus on which a workpiece is seated, and configured to perform multi-axis motion control of at least two axes with respect to the seated workpiece;
a welding apparatus disposed at one side of the welding positioner apparatus to face the workpiece seated on the welding positioner apparatus, and configured to weld the workpiece seated on the welding positioner apparatus by a welder mounted on an articulated robot;
a seam tracking apparatus disposed at the other side of the welding positioner apparatus to face the workpiece seated on the welding positioner apparatus from a position different from the welding apparatus, and configured to track a welding seam of a welding portion of the workpiece seated on the welding positioner apparatus by a seam tracking sensor mounted on an articulated robot; and
a controller configured to control multi-axis motion of the welding positioner apparatus such that the welding portion of the workpiece is positioned within an operation range of the welder of the welding apparatus and an operation range of the seam tracking sensor of the seam tracking apparatus.

2. The welding system of claim 1, wherein the welding positioner apparatus comprises:
a support stage on which the workpiece is seated;
a multi-axis motion unit configured to support the support stage to be rotatable based on at least a first rotational axis and a second rotational axis perpendicular to the first rotational axis so as to enable multi-axis motion control of at least two axes with respect to the support stage; and
a clamp module rotatably installed at both ends of a seating portion of the support stage on which the workpiece is seated so as to clamp the workpiece seated on the support stage, and configured to selectively press at least a portion of a lower frame of the workpiece; and
wherein the controller is configured to, during welding of the workpiece, control multi-axis motion of the multi-axis motion unit such that the welding portion of the workpiece is positioned within the operation range of the welder and the operation range of the seam tracking sensor.

3. The welding system of claim 2, wherein the multi-axis motion unit comprises:
a body frame;
a first motion module installed at one end of the body frame to support the support stage, and configured to rotate the support stage based on the first rotational axis; and
a second motion module installed at the other end of the body frame to support the body frame and configured to rotate the body frame based on the second rotational axis.

4. The welding system of claim 3, wherein the first motion module comprises:
a first motion body installed to contact both inner walls of the body frame so as to be positioned inside the body frame at one end of the body frame formed in an "H" shape as a whole;
a rotation plate installed on an upper side of the first motion body to be rotatable based on the first rotational axis, and configured to support the support stage; and
a first motion motor installed on a lower side of the first motion body, and configured to rotationally drive the rotation plate.

5. The welding system of claim 4, wherein the first motion body is rotatably installed based on a third rotational axis parallel to the second rotational axis at the one end of the body frame.

6. The welding system of claim 5, wherein the multi-axis motion unit further comprises:
a third motion module configured to rotationally drive the first motion body by a third motion motor installed at the one end of the body frame to contact an outer side wall of the body frame.

7. The welding system of claim 3, wherein the second motion module comprises:
a second motion body installed at the other end of the body frame formed in an "H" shape as a whole to contact both outer walls of the body frame, and configured to support the body frame in a cantilever configuration as a hinge part while supporting the body frame to be rotatable based on the second rotational axis; and
a second motion motor installed at one side of the second motion body, and configured to rotationally drive the body frame.

8. The welding system of claim 7, wherein the second motion module further comprises:
a support cylinder formed to have a variable length so as to support the one end of the body frame supported in the cantilever configuration by the second motion body or to assist rotational driving of the body frame by the second motion motor and connecting a lower end of the second motion body and the one end of the body frame.

9. The welding system of claim 7, wherein the multi-axis motion unit further comprises:
a fourth motion module configured to slide and move the second motion module in a linear axis perpendicular to the second rotational axis.

10. The welding system of claim 9, wherein the fourth motion module comprises:
a fourth motion body formed to extend in a rectangular parallelepiped shape along the linear axis;
a plurality of guide rails formed to extend in a rail configuration along the linear axis, and installed on an upper side of the fourth motion body;
a sliding stage installed on the upper side of the fourth motion body to be slidably movable along the plurality of guide rails, and configured to support the second motion body; and
a sliding drive unit installed at the fourth motion body, and configured to slide and drive the sliding stage.

11. The welding system of claim 10, wherein the sliding drive unit comprises:
a ball screw formed to extend in a rod shape along the linear axis, and rotatably installed on the upper side of the fourth motion body;
a movable nut coupled to a lower side of the sliding stage and screw-coupled to the ball screw, and installed to be slidably movable together with the sliding stage in an extension direction of the ball screw according to rotational driving of the ball screw; and
a fourth motion motor installed at one side of the fourth motion body, and configured to rotationally drive the ball screw.

12. The welding system of claim 2, wherein the controller is configured to control the welding apparatus such that the welder is operated along the welding seam tracked by the seam tracking sensor, and control multi-axis motion of the multi-axis motion unit such that the welding seam tracked by the seam tracking sensor is positioned within an operation range of the welder by the articulated robot.

13. The welding system of claim 1, wherein the seam tracking sensor includes at least one vision sensor so as to track the welding seam of the welding portion by vision inspection.
